(19) United States
(12) Patent Application Publication
(10) Pub. No.: US 2006/0002307 A1
(43) Pub. Date: Jan. 5, 2006

(54) Apparatus and method for testing a network connection device

(75) Inventors: Yi-Ming Wang, Hsinchu (TW); Chun-Ming Wang, Sinjhuang City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Accton Technology Corporation

(21) Appl. No.: 11/147,737

(22) Filed: Jun. 8, 2005

(30) Foreign Application Priority Data
Jun. 30, 2004 (TW) 93119796

(51) Int. Cl. H04L 1/00

(52) U.S. Cl. 370/242; 370/252

(57) ABSTRACT

A test apparatus for testing a to-be-tested network connection device is disclosed. The to-be-tested network connection device has a number of to-be-tested ports. The test apparatus includes a packet generator and a switch fixture. The packet generator is for generating a test packet having a VLAN ID (VID). The switch fixture, having VLAN function, includes a number of fixture ports. The to-be-tested ports are respectively one-to-one electrically coupled to the fixture ports. The switch fixture receives the test packet and transmits the test packet from one of the fixture ports to the corresponding to-be-tested port according to its VID in order to verify the to-be-tested network connection device.

This application claims the benefit of Taiwan application Serial No. 93119796, filed Jun. 30, 2004, the subject matter of which is incorporated herein by reference.

### BACKGROUND OF THE INVENTION

1. Field of the Invention

The invention relates in general to a test apparatus and method, and more particularly to an apparatus and method for testing a network connection device.

2. Description of the Related Art

A network connection device has several ports for connecting with a number of network access devices in order that these access devices can use and share network resources. The network connection device can be classified into hubs, switches, and routers according to function.

A hub receives data from one port and then transmits them to other ports while a switch can record a MAC address of the network access device connecting to a port and outputs the received data via the corresponding port according to the data's MAC address. Besides, the router outputs data via the corresponding port according to an IP address.

The network connection device requires a complicated process of packet test before leaving the factory in order to ensure that data received from each port can be output correctly and effectively. When a network device having a minority of ports is tested, each port's function can be tested manually one by one. When the tested network device has a lot of ports, a programmable relay box is generally used for testing each port. However, mechanic switching of the relay box is not quite fast, thereby enlarging the required test time. Besides, a Smartbit or IXIA standard test equipment can also be used to test a network device having lots of ports. However, these equipments are not in widespread use due to high cost.

### SUMMARY OF THE INVENTION

It is therefore an object of the invention to provide a fast and low-cost test apparatus and method for testing a network connection device.

The invention achieves the above-identified object by providing a test apparatus for testing a to-be-tested network connection device. The to-be-tested network connection device has a number of to-be-tested ports. The test apparatus includes a packet generator and a switch fixture. The packet generator is for generating a test packet having a VLAN ID (VID). The switch fixture, having VLAN function, includes a number of fixture ports. The to-be-tested ports are respectively one-to-one electrically coupled to the fixture ports. The switch fixture receives the test packet and transmits the test packet from one of the fixture ports to the corresponding to-be-tested port according to its VID.

The invention achieves the above-identified object by providing a test method. First, set the switch fixture in order that each of the fixture ports has a PVID. Next, generate a test packet having a VID. Afterward, receive the test packet by the switch fixture. Then by using the switch fixture, transmit the test packet via one of the fixture ports to the corresponding to-be-tested port according to the VID and the PVID so as to verify the to-be-tested network connection device.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic diagram of a test apparatus according to a preferred embodiment of the invention.

FIG. 2A is a flow chart of a test method for testing a network connection device by using the test apparatus in the embodiment.

FIG. 2B is a flow chart of constructing the lookup table in step 210.

FIG. 3 is a schematic diagram of a lookup table.

### DETAILED DESCRIPTION OF THE INVENTION

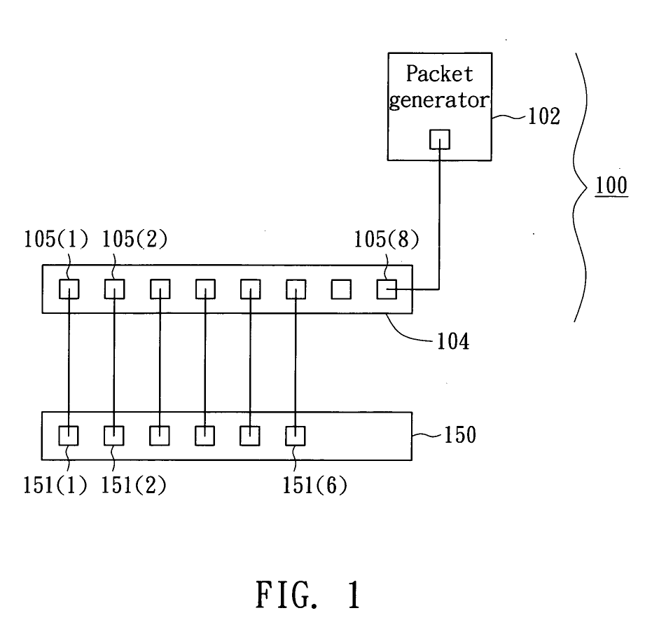

Referring to FIG. 1, a schematic diagram of a test apparatus according to a preferred embodiment of the invention is shown. The test apparatus 100 is for testing a to-be-tested network connection device 150. The to-be-tested network connection device 150 in the embodiment has 6 to-be-tested ports 151(1) to 151(6). Packets output by the test apparatus 100 have to be transmitted quickly and conveniently to an assigned to-be-tested port of the to-be-tested network connection device 150.

The test apparatus 100 includes a packet generator 102 and a switch fixture 104. In the embodiment, the switch fixture 104, having virtual local area network (VLAN) function, includes 8 fixture ports 105(1) to 105(8). The fixture port 105(8) is connected to the packet generator 102 while the fixture ports 105(1) to 105(6) are respectively one-to-one connected to the to-be-tested ports 151(1) to 151(6) via network cables. The packet generator 102, such as a computer, is for generating a test packet, and the test packet includes a tag having a VLAN ID (VID).

The switch fixture 104, having VLAN function, can set each fixture port to have an individual port VID (PVID) in order that each fixture port is corresponded to a different VLAN. For example, PVIDs of the fixture ports 105(1) to 105(6) are respectively 301 to 306. When the packet generator 102 is to transmit a test packet to the to-be-tested port 151(3) of the network connection device 159, the packet generator 102 will set the VID of the tested packet to be 303. After the switch fixture 104 receives the tested packet, it can transmit the packet via the corresponding fixture port 105(3) to the assigned to-be-tested port 151(3) according to the packet's VID. Through the VLAN function of the switch fixture 104, the test packet can be transmitted quickly and conveniently to an assigned to-be-tested port 151 of the to-be-tested network connection device 150 in a test process.

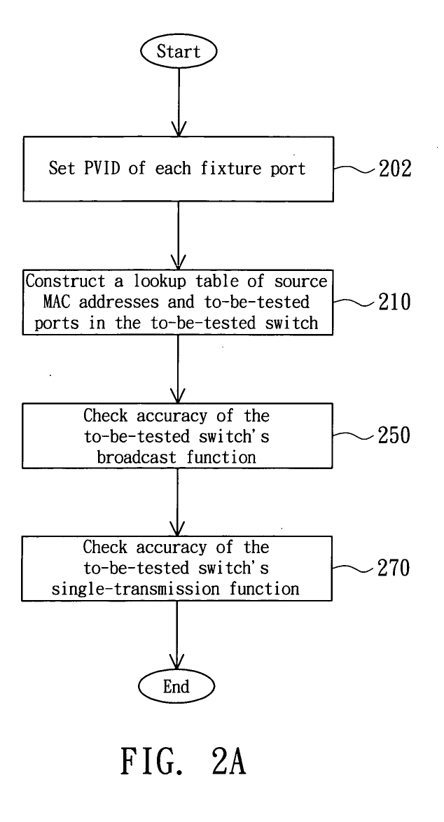

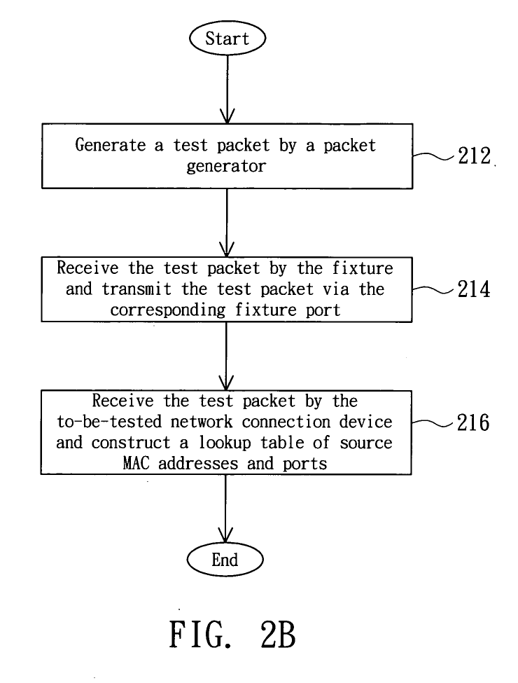

FIG. 2A is a flow chart of a test method for testing a network connection device by using the test apparatus in the embodiment. The network connection device 150 is exemplified as a switch. First, in step 202, set the PVID of each fixture port 105 in the switch fixture 104. For example, the PVIDs of the fixture ports 105(1) to 105(6) are respectively set to be 301 to 306.

Next, in step 210, generate a number of test packets by the packet generator 102 so as to construct a lookup table of source MAC addresses and to-be-tested ports in the to-be-tested switch 150. Afterward, in step 250, when the lookup table is completed, check the to-be-tested switch 150 for the broadcast function's accuracy. Last, in step 270, check the to-be-tested switch 150 for single-transmission function's accuracy.

FIG. 2B is a flow chart of constructing the lookup table in step 210. First, in step 212, generate a test packet by the packet generator 102. The test packet has a tag 301 for instance, a source MAC address A1, and a destination MAC address for broadcast. Next, in step 214, check the test packet's VID after the switch fixture 104 receives the test packet, and then output the test packet via the fixture port 105(1) corresponding to the PVID 301. In step 216, record the source MAC address A1 in the lookup table after the to-be-tested connection device 150 receives the test packet at the to-be-tested port 151(1), and broadcast the test packet out via other to-be-tested ports 151(2) to 151(6) according to the destination MAC address.

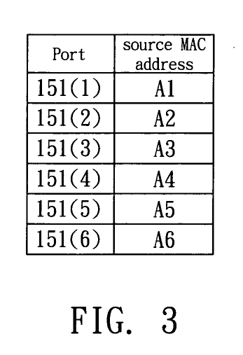

Repeat the step 212 to generate a number of test packets having VIDs of 302 to 306, source MAC addresses of A2 to A6 respectively, and destination MAC addresses for broadcast by the packet generator 102. Then the to-be-tested network connection device 150 can construct a complete lookup table of source MAC addresses and ports as shown in FIG. 3.

In step 250, check broadcast function's accuracy according to the total number of packets broadcasted by the to-be-tested network connection device 150 in the step 210. The network connection device 150 broadcasts the received test packet to other 5 ports and there are totally 6 packets generated by the packet generator 6 in lookup table construction process, so there should be 5*6=30 packets broadcasted out. The to-be-tested connection device 150 has Remote Monitoring (RMON) function for testing accuracy of transmitted packets' number to ensure accuracy of the to-be-tested network connection device's broadcast function.

In addition, in order to verify the broadcast function's accuracy, packets output by the to-be-tested network connection device 150 can also be forwarded to the packet generator 102 by using packet forward function, or packets received by the switch fixture 104 can also be forwarded to the packet generator 102 via the network connection device 150.

FIG. 2B is a flow chart of single-transmission function for checking the to-be-tested network connection device 150 in the step 270. The single-transmission function is to check the packet's destination MAC address as it is received by the network connection device 150 and output the packet via the corresponding port according to the lookup table. For example, when the port 151(2) receives a packet whose destination MAC address is A3, the network connection device 150 will output the packet via the port 151(3) according to the lookup table in FIG. 3.

When testing the single-transmission function, first, generate a test packet, which has a VID of 301 and a destination MAC address of A2 for instance, by the packet generator 102 for the input to the to-be-tested port 151(1), and check whether the packet is outputted only via the to-be-tested port 151(2). By the same method, the packet generator 102 tests the to-be-tested ports one by one to verify whether the to-be-tested network device 150 correctly performs the single-transmission function according to a lookup table.

According to the above-mentioned embodiment of the invention, the test apparatus and method has the advantages of low cost and high test speed by using a switch having VLAN function as a fixture to quickly test each port of the to-be-tested network connection device.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A test apparatus, for testing a to-be-tested network connection device, the to-be-tested network connection device having a plurality of to-be-tested ports, the test apparatus comprising:
a packet generator, for generating a test packet, the test packet having a virtual local area network (VLAN) ID (VID); and
a switch fixture having VLAN function, comprising a plurality of fixture ports, each fixture port having a port VID (PVID), wherein the to-be-tested ports are respectively one-to-one electrically coupled to the fixture ports;
wherein the switch fixture receives the test packet and transmits the test packet from one of the fixture ports to the corresponding to-be-tested port according to the VID and the PVIDs.

2. The test apparatus according to claim 1, wherein the packet generator is a computer.

3. The test apparatus according to claim 1, wherein the PVIDs of the fixture ports are different from each other.

4. The test apparatus according to claim 1, wherein the to-be-tested network connection device is a switch.

5. A test method, for testing a to-be-tested network connection device by a switch fixture, the to-be-tested network connection device having a plurality of to-be-tested ports, the switch fixture having VLAN function and having a plurality of fixture ports, the to-be-tested ports respectively one-to-one electrically coupled to the fixture ports, the test method comprising:
setting the switch fixture in order that each of the fixture ports has a PVID;
generating a test packet having a VID; and
receiving the test packet by the switch fixture; and
transmitting the test packet via one of the fixture ports to the corresponding to-be-tested port by the switch fixture according to the VID and the PVID to verify the to-be-tested network connection device.

6. The test method according to claim 5, wherein the step of generating the test packet is performed by a packet generator.

7. The test method according to claim 5, wherein in the step of setting the switch fixture, the PVIDs of the fixture ports are different from each other.

8. The test method according to claim 5, wherein the to-be-tested network connection device is a switch.

9. A test method, for testing a to-be-tested network connection device by a switch fixture, the to-be-tested network connection device having a plurality of to-be-tested ports, the switch fixture having VLAN function and having a plurality of fixture ports, the to-be-tested ports respectively one-to-one electrically coupled to the fixture ports, the test method comprising:
setting the switch fixture in order that each of the fixture ports has a PVID;
generating a plurality of first test packets, each of the first test packets having a VID; and
constructing a lookup table in the to-be-tested network connection device according to the first test packets, wherein the switch fixture outputs each of the first test packets via one of the fixture ports according to the corresponding VID and PVID;
generating a plurality of second test packets, each of the second test packets having a VID; and
testing a single-transmission function of the to-be-tested network connection device according to the second test packets, wherein the switch fixture outputs each of the second test packets via one of the fixture ports to the to-be-tested network connection device according to the corresponding VID and PVID.

10. The test method according to claim 9, wherein in the step of constructing the lookup table, each of the first test packet comprises a source MAC address, and the to-be-tested network connection device constructs the lookup table according to relation between the source MAC addresses and the to-be-tested ports.

11. The test method according to claim 9, further comprising:
checking broadcast function of the to-be-tested network connection device according to the first test packets, wherein each of the first test packets comprises a destination MAC address for broadcast.

12. The test method according to claim 9, wherein in the step of testing the single-transmission function, the to-be-tested network connection device outputs each of the received second test packets via the corresponding to-be-tested port according to the lookup table.
